(19) United States
(12) Patent Application Publication
(10) Pub. No.: US 2023/0093207 A1
(43) Pub. Date: Mar. 23, 2023

(54) Device and Method for Assisting a Driver of an Autonomous Vehicle

(71) Applicant: Bayerische Motoren Werke Aktiengesellschaft, Muenchen (DE)

(72) Inventors: Boris ISRAEL, Muenchen (DE); Felix LAUBER, Muenchen (DE); Desiree MEYER, Stockdorf (DE); Frederik PLATTEN, Muenchen (DE)

(21) Appl. No.: 17/795,308

(22) PCT Filed: Jan. 13, 2021
(86) PCT No.: PCT/EP2021/050581

§ 371 Date: Jul. 26, 2022

(30) Foreign Application Priority Data
Jan. 27, 2020 (DE) 10 2020 101 894.0

(51) Int. Cl. B60W 50/14; B62D 1/06

(52) U.S. Cl. CPC B60W 50/14; B62D 1/06

(57) ABSTRACT

A device for assisting a driver of a vehicle with at least partially automated longitudinal and/or lateral control. The device is designed to determine automation information with respect to the level of automation of the longitudinal and/or lateral control that is being used to operate the vehicle. The device is also designed to adjust the dimensions of a light signal, produced by a lighting element of the vehicle, according to the automation information.

### BACKGROUND AND SUMMARY

The invention relates to a device and a method which assist a driver of an at least partially autonomous vehicle when driving the vehicle.

A vehicle can have one or more driving functions which enable at least partially automated driving of the vehicle. The one or more driving functions can each have different degrees of automation of the longitudinal and/or lateral control of the vehicle. For example, one driving function can be designed as a driver assistance system which enables partially automated longitudinal and/or lateral control of the vehicle according to SAE level 2. On the other hand, another driving function can enable, for example, highly automated driving according to SAE level 3.

The driving tasks which are to be carried out by drivers of the vehicle are typically different depending on the degree of automation of the respective active driving function. For example, in the case of a driving function according to SAE level 2, the driver of a vehicle is typically still responsible for monitoring the longitudinal and/or lateral control of the vehicle. On the other hand, in the case of a driving function according to SAE level 3, at least temporarily, typically no monitoring by the driver of the vehicle is required.

The one or more driving functions can be designed in such a way that the driving behavior of the vehicle is similar or identical in the case of different driving functions having different degrees of automation. This can have the result that it is not readily recognizable to the driver of the vehicle which driving function is active in each case. As a result, it can possibly be unclear to the driver of the vehicle which driving task he or she has to carry out at a specific point in time.

The present document relates to the technical object of assisting the driver of a vehicle when driving a vehicle that has driving functions having different degrees of automation, in particular to increase the level of comfort and/or safety of the vehicle.

The above-mentioned object is achieved by each individual one of the independent claims. Advantageous embodiments are described, inter alia, in the dependent claims. It is to be noted that additional features of a claim dependent on an independent claim, without the features of the independent claim or only in combination with a subset of the features of the independent claim, can form a separate invention independent of the combination of all features of the independent claim, which can be made the subject matter of an independent claim, a divisional application, or a subsequent application. This applies in the same manner to technical teachings described in the description which can form an invention independent of the features of the independent claims.

The term “automated driving” can be understood in the scope of the document as driving having automated longitudinal or lateral control or automated driving having automated longitudinal and lateral control. Automated driving can involve, for example, driving over a longer time on the freeway or driving for a limited time in the context of parking or maneuvering. The term “automated driving” comprises automated driving with an arbitrary degree of automation. Exemplary degrees of automation are assisted, partially automated, highly automated, or fully automated driving. These degrees of automation were defined by the Bundesanstalt für Straßenwesen [German Federal Highway Research Institute] (BASt) (see BASt publication “Forschung kompakt [Compact Research]”, edition November 2012). In assisted driving, the driver continuously executes the longitudinal or lateral control, while the system takes over the respective other function in certain limits. In partially automated driving (TAF), the system takes over the longitudinal and lateral control for a certain period of time and/or in specific situations, wherein the driver has to continuously monitor the system as in assisted driving. In highly automated driving (HAF), the system takes over the longitudinal and lateral control for a certain period of time without the driver having to continuously monitor the system; however, the driver has to be capable of taking over the vehicle control in a certain time. In fully automated driving (VAF), the system can automatically manage the driving in all situations for a specific application; a driver is no longer necessary for this application. The above-mentioned four degrees of automation correspond to the SAE levels 1 to 4 of the standard SAE J3016 (SAE—Society of Automotive Engineering). For example, highly automated driving (HAF) corresponds to level 3 of the standard SAE J3016. Furthermore, the SAE level 5 is also provided as the highest degree of automation in SAE J3016, which is not included in the definition of the BASt. The SAE level 5 corresponds to driverless driving, in which the system can automatically manage all situations like a human driver during the entire journey; a driver is generally no longer required.

According to one aspect, a device for assisting a driver of a (motor) vehicle having at least partially automated longitudinal and/or lateral control is described. The automated longitudinal and/or lateral control can have different degrees of automation here, in particular different SAE levels. For example, the vehicle can be designed (depending on which driving function is active in each case) to provide an automated longitudinal and/or lateral control according to SAE level 1, 2, 3, or possibly 4.

The device (for example, a control unit of the vehicle) can be configured to determine automation information with respect to the degree of automation of the longitudinal and/or lateral control using which the vehicle is operated (at a current time). In particular, it can possibly be determined according to the SAE level at which the vehicle is (currently) operated.

Furthermore, the device can be configured to set and/or adjust the dimension of (at least) one light signal generated by (at least) one lighting element of the vehicle (at the current time) as a function of the automation information, in particular as a function of the degree of automation. The one or more lighting elements can each be designed in particular to generate light signals having different lengths. The device can then cause the length of the light signals generated by the one or more lighting elements to be set and/or adjusted as a function of the automation information, in particular as a function of the degree of automation.

The lighting element can comprise, for example, a plurality of partial segments which can each be activated individually. The individual partial segments can each comprise, for example, one or more LEDs (light-emitting diodes). The individual partial segments can be arranged adjacent to one another, in particular along a line. By increasing the number of active partial segments, the dimension, in particular the length, of the generated light signal can then be increased. On the other hand, the dimension, in particular the length, of the generated light signal can be reduced by reducing the number of active partial segments.

The lighting element can be arranged at a point of the vehicle which faces toward the driver position of the vehicle, so that the light signal, in particular the lighting element, can be seen by the driver of the vehicle when driving the vehicle.

The device thus enables the driver of a vehicle to be informed about the degree of automation of the longitudinal and/or lateral control of the vehicle by the dimension, in particular by the length, of at least one generated light signal. The driver of the vehicle can thus be informed in an efficient and clear manner about the driving tasks which are to be carried out by the driver (depending on the currently set degree of automation). As a result, the comfort and the safety of the vehicle can be increased.

The device can be configured to effectuate a light signal having a dimension greater than a dimension threshold if the automation information indicates that the degree of automation is greater than or equal to an automation threshold value, in particular is greater than or equal to a defined SAE level. Alternatively or additionally, the device can be configured to effectuate a light signal having a dimension less than the dimension threshold value if the automation information indicates that the degree of automation is less than the automation threshold value, in particular is less than the defined SAE level.

Furthermore, the device can be configured to increase the dimension of the light signal with rising degree of automation and/or to reduce the dimension of the light signal with sinking degree of automation.

The level of the degree of automation can thus be indicated clearly by the dimension, in particular by the length, of the light signal. The comfort and the safety of the vehicle can thus be increased further.

The vehicle can have a plurality of different degrees of automation, in particular of driving functions having different SAE levels. For example, 2 or more or 3 or more different degrees of automation of the longitudinal and/or lateral control of the vehicle can be provided.

The device can be configured to set the dimension, in particular the length, of the generated light signal in steps (for example, in 2 or more or in 3 or more steps) as a function of the respective existing degree of automation from the plurality of different degrees of automation. Each degree of automation can thus be associated with a corresponding, fixed dimension, in particular a corresponding, fixed length of the light signal. The driver of the vehicle (after a learning phase) can thus be informed in a particularly efficient and reliable manner on the basis of the light signal about the respective current degree of automation. As a result, the safety and the comfort of the vehicle can be increased further.

The lighting element can be designed in such a way that a maximum possible dimension of the generated light signal is recognizable to the driver of the vehicle, even if the lighting element is not generating a light signal. For this purpose, the lighting element can face toward the driver of the vehicle and can be visible to the driver of the vehicle from the driver position.

Furthermore, the vehicle can have a maximum possible degree of automation of the longitudinal and/or lateral control (in particular a driving function having a maximum possible SAE level).

The device can be configured to effectuate a light signal having maximum possible dimension if the automation information indicates that the vehicle is operated using the maximum possible degree of automation of the longitudinal and/or lateral control. Alternatively or additionally, the device can be configured to effectuate a light signal having a dimension which is less than the maximum possible dimension if the automation information indicates that the vehicle is operated using a degree of automation which is less than the maximum possible degree of automation.

A visible reference for a maximum possible degree of automation can thus be provided. This enables the driver of the vehicle to acquire the respective currently set degree of automation from the dimension, in particular from the length, of the generated light signal in a particularly reliable and precise manner. The comfort and the safety of the vehicle can thus be increased further.

The lighting element can be configured, for example, to generate a light signal which has 100% of the maximum possible dimension. A light signal having 100% of the maximum possible dimension can be used to indicate the maximum possible degree of automation (i.e., 100% of the maximum possible degree of automation). If the vehicle has no automation (i.e., a degree of automation of 0% of the maximum possible degree of automation), possibly no light signal can be generated (i.e., a light signal having 0% of the maximum possible dimension). For degrees of automation between 0% and 100% of the maximum possible degree of automation, the dimension of the light signal (corresponding to the percentage of the degree of automation) can be set between 0% and 100% of the maximum possible dimension. In particular, a light signal having x % of the maximum possible dimension can be generated for a degree of automation of x % of the maximum possible degree of automation. The degree of automation can be communicated in a particularly precise manner to the driver of the vehicle by such a proportionality between degree of automation and dimension of the generated light signal.

The vehicle can comprise a steering wheel, and the (at least one) lighting element can be arranged in one preferred example on the steering wheel, in particular on the steering wheel rim and/or on one or more spokes of the steering wheel.

The steering wheel is typically arranged directly in front of the driver position of the vehicle, so that the light signal effectuated by the lighting element can be acquired in a particularly reliable manner by the driver of the vehicle (without the driver having to look away from the traffic). The comfort and the safety of the vehicle can thus be increased further.

In one particularly preferred example, the lighting element can extend linearly along at least 25%, in particular at least 40%, of the circumference of the steering wheel rim. It is then possible to effectuate that a linear light signal is generated by the linear lighting element, wherein the length of the light signal is dependent on the degree of automation of the longitudinal and/or lateral control using which the vehicle is operated. The degree of automation of the vehicle can thus be acquired in a particularly reliable and comfortable manner by the driver of the vehicle.

The at least one lighting element can be designed to generate light signals in different colors. The device can be configured to set the color of the light signal as a function of the automation information, in particular as a function of the degree of automation of the longitudinal and/or lateral control using which the vehicle is operated. The (respective currently used or provided) degree of automation of the vehicle can be communicated with particularly high reliability to the driver of the vehicle by the use of different colors.

According to a further aspect, a (road) motor vehicle (in particular a passenger vehicle or a truck or a bus or motorcycle) is described, which comprises the device described in this document.

According to a further aspect, a method for assisting a driver of a vehicle having at least partially automated longitudinal and/or lateral control is described. The method comprises determining automation information with respect to a degree of automation of the longitudinal and/or lateral control using which the vehicle is operated. Furthermore, the method comprises setting and/or adjusting the dimension, in particular the length, of a light signal generated by a lighting element of the vehicle as a function of the automation information, in particular as a function of the degree of automation.

According to a further aspect, a software (SW) program is described. The SW program can be configured to be executed on a processor (for example, on a control unit of a vehicle), and to thus execute the method described in this document.

According to a further aspect, a storage medium is described. The storage medium can comprise an SW program, which is configured to be executed on a processor, and to thus execute the method described in this document.

It is to be noted that the methods, devices, and systems described in this document can be used both alone and also in combination with other methods, devices, and systems described in this document. Furthermore, any aspects of the methods, devices, and systems described in this document can be combined in manifold ways with one another. In particular, the features of the claims can be combined with one another in manifold ways.

The invention is described in more detail hereinafter on the basis of exemplary embodiments.

### BRIEF DESCRIPTION OF THE DRAWINGS

FIG. 1A shows exemplary components of a vehicle;

FIG. 1B shows an exemplary steering wheel of a vehicle;

FIG. 2A shows an exemplary lighting element which indicates a relatively high degree of automation;

FIG. 2B shows an exemplary lighting element which indicates a relatively low degree of automation; and

FIG. 3 is a flow chart of an exemplary method for assisting a driver of a vehicle which has different driving functions having different degrees of automation.

### DETAILED DESCRIPTION OF THE DRAWINGS

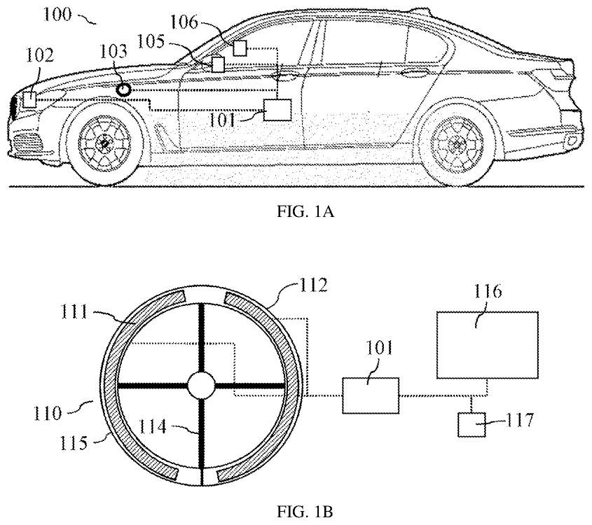

As described at the outset, the present document relates to the efficient and reliable assistance of a driver of a vehicle, which has different driving functions having different degrees of automation. In this context, FIG. 1A shows exemplary components of a vehicle 100, in particular a motor vehicle. The vehicle 100 comprises one or more surroundings sensors 102, which are configured to acquire sensor data (in this document also referred to as surroundings data) with respect to the surroundings of the vehicle 100. Exemplary surroundings sensors 102 are a camera, a radar sensor, a lidar sensor, an ultrasonic sensor, etc.

The vehicle 100 furthermore comprises one or more longitudinal and/or lateral control actuators 103 (e.g., a drive motor, a braking device, a steering device, etc.), which are configured to longitudinally and/or laterally control the vehicle 100 automatically or in an automated manner. A control unit 101 (or a device) of the vehicle 100 can be configured to operate the one or more longitudinal and/or lateral control actuators 103 of the vehicle as a function of the surroundings data in order to longitudinally and/or laterally control the vehicle 100 in an automated manner (in particular according to SAE level 1, according to SAE level 2, according to SAE level 3, or higher).

The vehicle 100 comprises one or more manual control devices 105, which enable the driver of the vehicle 100 to make manual control inputs with respect to the longitudinal and/or lateral control of the vehicle 100. Exemplary control devices 105 are: a steering wheel, brake pedal, and/or an accelerator pedal. The control unit 101 can be configured (in particular when the vehicle 100 is operated in a manual driving mode) to detect a manual control input at a manual control device 105 of the vehicle 100. Furthermore, the control unit 101 can be configured to operate the one or more longitudinal and/or lateral control actuators 103 of the vehicle 100 as a function of the manual control input, in particular to enable the driver of the vehicle 100 to longitudinally and/or laterally control the vehicle 100 manually.

The vehicle 100 can comprise a user interface 106, which enables an interaction between the vehicle 100 and the driver of the vehicle 100. The user interface 106 can comprise one or more operating elements (e.g., a button, a rotary knob, etc.) and/or one or more output elements (e.g., a display screen, a lighting element, a loudspeaker, etc.). The control unit 101 can be configured to output an optical, haptic, and/or acoustic notice to the driver of the vehicle 100 via the user interface 106. Furthermore, it can be made possible for the driver of the vehicle 100 to activate or deactivate one or more driving functions having different degrees of automation via the user interface 106.

FIG. 1B shows exemplary components of a vehicle 100 at the driver position of the vehicle 100. In particular, FIG. 1B shows a steering wheel 110 as an exemplary manual control device 105, which enables the driver of the vehicle 100 to steer the vehicle 100 manually. One or more touch sensors (not shown) can be arranged on the steering wheel 110, which are configured to detect whether the driver of the vehicle 100 touches the steering wheel 110 with at least one hand. The control unit 101 can be configured to determine on the basis of the sensor data of the one or more touch sensors of the steering wheel 110 whether the driver of the vehicle 100 is touching the steering wheel 110 with at least one hand, touches it with two hands, or does not touch it. Furthermore, FIG. 1B shows a display screen 116 and a loudspeaker 117 as exemplary components of the user interface 106.

The steering wheel 110 furthermore has one or more lighting elements 111, 112, which can be activated or deactivated. A lighting element 111, 112 preferably has an elongated shape. In particular, a lighting element 111, 112 can be designed in such a way that the lighting element 111, 112 extends linearly along the circumference of the steering wheel rim 115. For example, a lighting element 111, 112 can extend over an angle range of 45° or more, in particular of 90° or 120° or more, along the circumference of the steering wheel rim 115.

A linear lighting element 111, 112 can have a plurality of partial segments (each having one or more LEDs), which can each be activated or deactivated individually. In other words, a linear lighting element 111, 112 can be designed in such a way that if needed only a part of the lighting element 111, 112 is activated, so that the length of a linear light signal emitted by the lighting element 111, 112 can be changed, in particular reduced or increased.

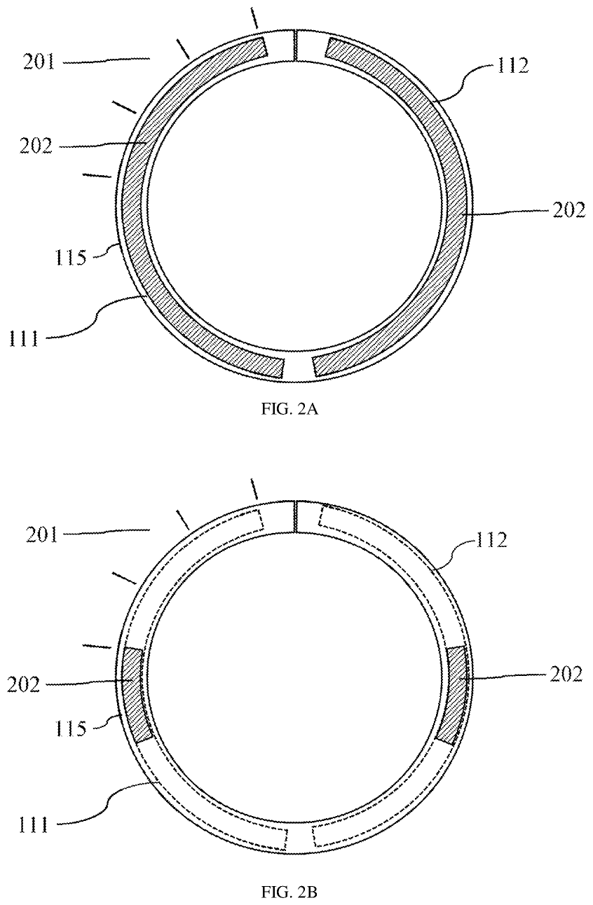

FIGS. 2A and 2B show exemplary linear light signals 202 which can be generated using the one or more lighting elements 111, 112. In particular, FIG. 2A shows a light signal 202 having a relatively large length 201 and FIG. 2B shows a light signal 202 having a relatively small length 201. The one or more lighting elements 111, 112 can be designed, for example, in such a way that the length 201 of the respective generated light signals 202 can be changed in multiple steps (shown by the dashes in FIGS. 2A and 2B). For example, 3 or more or 5 or more steps can be enabled (for a corresponding number of different degrees of automation).

The vehicle 100 can thus have at least one lighting element 111, 112, which is designed to change the geometry and/or the shape of a light signal 202 that is emitted by the respective light signal 202. In particular the dimension, for example, the length 201, of the light signal 202 can be changed in this case.

As described at the outset, the vehicle 100 can have different driving functions each having different degrees of automation, in particular each having different SAE levels. Exemplary driving functions having an SAE level 1 are driver assistance functions such as adaptive cruise control (ACC) or a lane keeping assistant. Exemplary functions having an SAE level 2 are a combination of ACC and lane keeping assistant or an overtaking assistant or parking assistant. An exemplary driving function having an SAE level 3 is a freeway assistant.

The requirements for the driver of the vehicle 100 are typically different for the different degrees of automation. For example, the driver of the vehicle 100 in the case of a driving function according to SAE level 1 typically has to keep both hands on the steering wheel 110 and/or he has to monitor the vehicle 100 continuously. In the case of a driving function according to SAE level 2, it can possibly be sufficient if the driver of the vehicle 100 only keeps one hand on the steering wheel 110, wherein typically the vehicle 100 still has to be continuously monitored. In the case of a driving function from SAE level 3, it can possibly be enabled that the driver of the vehicle 100 takes their hands from the steering wheel 110 and at least temporarily no longer monitors the vehicle 100.

The driving behavior of the vehicle 100 can also be similar or identical in the case of different driving functions having different degrees of automation. In particular, it can be difficult or impossible for the driver of the vehicle 100 to recognize solely on the basis of the driving behavior of the vehicle 100 which driving function is active and/or with which degree of automation, in particular with which SAE level, the vehicle 100 is operated at a specific point in time. As a result, it can possibly be unclear for the driver of the vehicle 100 at a specific point in time which driving task he is to perform himself and/or to what extent the longitudinal and/or lateral control of the vehicle 100 is performed automatically. For example, it can be unclear for the driver whether or not the steering wheel 110 has to be held at a specific point in time, or whether on the contrary the steering wheel 110 is not supposed to be held (so as not to negatively affect the automated lateral control of the vehicle 100).

The control unit 101 of the vehicle 100 can be configured to determine, at a specific point in time, automation information with respect to the degree of automation, in particular with respect to the SAE level, of the vehicle 100 at the specific point in time. The automation information can indicate in particular with which degree of automation the vehicle 100 is operated at the specific point in time.

Furthermore, the control unit 101 can be configured to adapt the geometry, in particular the dimension, of the light signal 202 generated by at least one lighting element 111, 112 of the vehicle 100 as a function of the automation information. In particular, the length 201 of the generated light signal 202 can be increased with rising degree of automation or reduced with sinking degree of automation. The light signal 202 shown in FIG. 2A can be used, for example, to indicate a relatively high degree of automation, for example, a degree of automation according to SAE level 3 or higher. On the other hand, the light signal 202 shown in FIG. 2B can be used, for example, to indicate a relatively low degree of automation, for example, a degree of automation according to SAE level 2 or SAE level 1.

A lighting element 111, 112 on the steering wheel 110, in particular on the steering wheel rim 115 or on the one or more spokes 114 of the steering wheel 110, is preferably used to indicate the degree of automation. The steering wheel 110 is located in the immediate vicinity of the driver, directly in front of the driver, and is therefore suitable in a particularly advantageous manner to indicate the degree of automation. Furthermore, an obligation is possibly connected to the respective degree of automation to grasp the steering wheel rim 115 of the vehicle 100 using one or both hands. The driver of the vehicle 100 can be notified of this obligation in a particularly comfortable and reliable manner by the use of a lighting element 111, 112 directly on the steering wheel rim 115.

A quantification of the assistance (e.g., relatively much, relatively little, or more than in comparison to previously) and/or the responsibility of the driver can thus be represented via at least one lighting element 111, 112 of the vehicle 100. For example, it can be indicated to the driver at SAE level 2 (for example, ACC plus lane keeping assistance, or parking) and/or at SAE level 3, that the driver no longer has to actively intervene in the lateral control of the vehicle 100 (for example by steering) and/or in the longitudinal control of the vehicle 100 (e.g., by braking, by giving gas, or by setting the distance to the front vehicle). Furthermore, it can be made recognizable to the driver that during a parking function, hands-on is not required, so that the driver can or should take the hands from the steering wheel 110. The different tasks of the driver with different degrees of automation can be communicated in an efficient and clear manner by the display operating concept described in this document.

In particular, a differentiation with respect to the responsibility of the driver can be indicated via one or more lighting elements 111, 112 in the spokes 114 and/or on the steering wheel rim 115 of the steering wheel 110 via a geometric coding. The more automation is active at a point in time, the larger the actively illuminated component of the one or more lighting elements 111, 112 can be.

In addition to the geometric coding, a color differentiation can possibly be made between the different degrees of automation (for example, SAE level 2=green or SAE level 3=blue). The differentiation between different degrees of automation can thus be communicated in a particularly clear manner. However, the degree of the assistance of the driver, i.e., the degree of automation, is already recognizable at a glance for the driver due to a geometric coding.

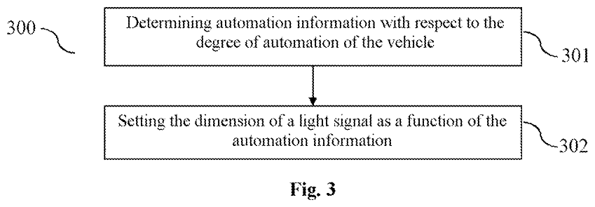

FIG. 3 shows a flow chart of an exemplary (computer-implemented) method 300 for assisting a driver of a vehicle 100 having at least partially automated longitudinal and/or lateral control. The vehicle 100 can have different driving functions for automated longitudinal and/or lateral control of the vehicle 100, wherein the different driving functions have different degrees of automation, in particular different SAE levels. Alternatively or additionally, the different driving functions (possibly complementary to the respective degree of automation) can have different requirement levels with respect to the cooperation of the driver of the vehicle 100. The requirement level for the cooperation of the driver typically sinks with rising degree of automation of the longitudinal and/or lateral control (and/or vice versa).

The method 300 comprises the determination 301 of automation information with respect to the degree of automation of the longitudinal and/or lateral control, using which the vehicle 100 is operated. In particular, it can be determined which one or more driving functions were activated (possibly by the driver) or are active. The (current) degree of automation can then result from the one or more driving functions active (at the respective point in time).

The method 300 furthermore comprises the setting 302 of the dimension of a light signal 202 generated by a lighting element 111, 112 of the vehicle 100 (in the interior or in the passenger compartment of the vehicle 100) as a function of the automation information, in particular as a function of the (current) degree of automation. It can thus be effectuated that the (respective current) degree of automation is indicated by the dimension, in particular by the length 201, of a (currently) generated light signal 202.

By way of the measures described in this document, the driver of a vehicle 100 which has driving functions having different degrees of automation can be assisted in a particularly comfortable and safe manner in the control of the vehicle 100. The safety of the vehicle 100 can thus be increased.

The present invention is not restricted to the exemplary embodiments shown. In particular, it is to be noted that the description and the figures are only to illustrate the principle of the proposed methods, devices, and systems by way of example.

1.-11. (canceled)

12. A device for assisting a driver of a vehicle equipped with at least partially automated longitudinal and/or lateral control, comprising:
a control unit operatively configured to:
determine automation information with respect to a degree of automation of the longitudinal and/or lateral control that is being used to operate; and
set a dimension of a light signal generated by a lighting element of the vehicle as a function of the automation information.

13. The device according to claim 12, wherein
the dimension of the light signal is set as a function of the degree of automation.

14. The device according to claim 13, wherein
the lighting element is designed to generate light signals having different lengths, and
the control unit is configured to adapt a length of the light signal generated by the lighting element as a function of the degree of automation.

15. The device according to claim 13, wherein the control unit is configured to:
effectuate a light signal having a dimension greater than a dimension threshold value when the automation information indicates that the degree of automation is greater than an automation threshold value, and/or
effectuate a light signal having a dimension less than the dimension threshold value when the automation information indicates that the degree of automation is less than the automation threshold value.

16. The device according to claim 15, wherein
the automation threshold value is a defined SAE level.

17. The device according to claim 12, wherein the control unit is configured to:
increase the dimension of the light signal with an increasing degree of automation; and/or
reduce the dimension of the light signal with a decreasing degree of automation.

18. The device according to claim 12, wherein
the vehicle has a plurality of different degrees of automation, and
the control unit is configured to set the dimension of the generated light signal step-by-step as a function of the respective existing degree of automation from the plurality of different degrees of automation.

19. The device according to claim 12, wherein
the lighting element is designed such that a maximum possible dimension of the generated light signal is recognizable to the driver of the vehicle, even when the lighting element does not generate a light signal,
the vehicle has a maximum possible degree of automation of the longitudinal and/or lateral control, and
the control unit is configured to:
effectuate a light signal having maximum possible dimension when the automation information indicates that the vehicle is operated using the maximum possible degree of automation of the longitudinal and/or lateral control; and
effectuate a light signal having a dimension less than the maximum possible dimension when the automation information indicates that the vehicle is operated using a degree of automation which is less than the maximum possible degree of automation.

20. The device according to claim 12, wherein
the vehicle comprises a steering wheel, and
the lighting element is arranged on the steering wheel.

21. The device according to claim 20, wherein
the lighting element is arranged on a steering wheel rim and/or on one or more spokes of the steering wheel.

22. The device according to claim 20, wherein
the lighting element extends linearly along at least 25% of the circumference of the steering wheel rim,
the control unit is configured to effectuate that a linear light signal is generated by the linear lighting element, and
the length of the light signal is dependent on the degree of automation of the longitudinal and/or lateral control being used to operate the vehicle.

23. The device according to claim 12, wherein
the lighting element is designed to generate light signals in different colors, and
the control unit is configured to set a color of the light signal as a function of the degree of automation of the longitudinal and/or lateral control being used to operate the vehicle.

24. The device according to claim 12, wherein
the automation information indicates an SAE level, according to which the vehicle is operated, and
the lighting element is designed to generate light signals of different dimensions for different SAE levels.

25. A method for assisting a driver of a vehicle equipped with at least partially automated longitudinal and/or lateral control, the method comprising:
determining automation information with respect to a degree of automation of the longitudinal and/or lateral control being used to operate the vehicle; and
setting a dimension of a light signal generated by a lighting element of the vehicle as a function of the degree of automation.
